(19) United States
(12) Patent Application Publication
(10) Pub. No.: US 2005/0007976 A1
(43) Pub. Date: Jan. 13, 2005

(54) Charging in communication networks

(76) Inventors: Juha-Pekka Koskinen, Hameenlinna (FI); Juha Vallinen, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/480,095

(22) PCT Filed: May 30, 2003
(86) PCT No.: PCT/IB03/02604

(30) Foreign Application Priority Data
Jun. 10, 2002 (GB) 0213255.3

(51) Int. Cl. H04Q 7/00

(52) U.S. Cl. 370/328

(57) ABSTRACT

A communication system for supporting a communication session of a terminal, the communication system comprising: at least one charging unit arranged to monitor the communication session and generate a plurality of charging messages together indicating a total charge for the communication session; a primary charging data collection unit, a secondary charging data collection unit and a backup charging data collection unit, each charging collection unit being capable of receiving and correlating charging messages for the communication session; wherein: the or each charging unit is arranged to transmit the charging messages to the primary charging data collection unit or, if the charging unit determines that a charging message for the communication session has not been correctly received by the primary charging data collection unit, to die secondary charging data collection unit; and the primary and secondary charging data collection units are arranged to, if they have received only some of the charging messages for the communication session, transmit the content of the charging messages that they have received for the session to the backup charging data collection unit.

This invention relates to charging in communication networks, especially third generation (UMTS) networks.

The implementation of charging systems in third generation (3G) networks presents a number of difficulties. Some of these are detailed below.

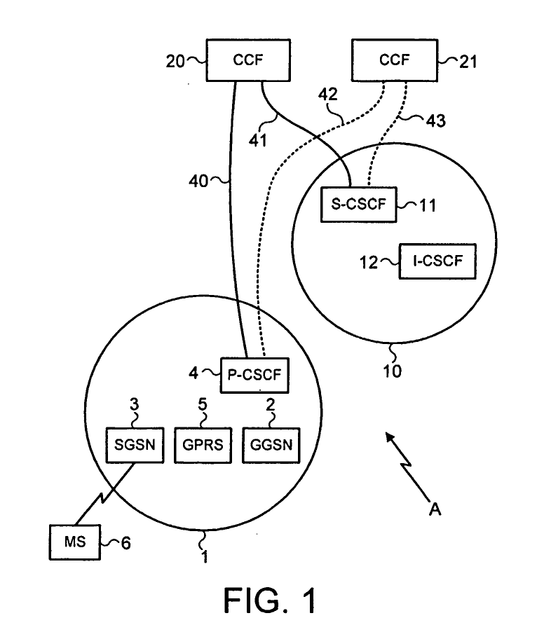

The proposed architecture for charging in 3G networks is illustrated in FIG. 1. The system of FIG. 1 includes a third generation communication network A. The network has a core network section and other peripheral network units. Only the units that are pertinent to the present description are shown in FIG. 1.

The core network VPLMN (Visiting Public Land Mobile Network) 1 of network A comprises a GGSN (gateway GPRS support node) 2, an SGSN (serving GPRS support node) 3, a P-CSCF (proxy call server control function) 4 and a GPRS (general packet radio service) support unit 5. A subscriber terminal 6 is attached to network A. For the purpose of this example, network A is he home network of the subscriber of mobile station terminal 6. Network A also has a core network HPLMN (home public land mobile network) 10. The HPLMN comprises a S-CSCF (serving call server control function) 11 and an I-CSCF (interrogating call server control function) 12.

There is also a CCF (charging collection function) unit 20 available to network A. CCF 20 could be part of network A or could be elsewhere. The CCF is responsible for collecting information on charges to a subset of mobile subscribers, in this example including the subscriber of terminal 6. Each network may include more than one CCF to handle multiple subsets of subscribers. The CCF may also be known as a CCP (charging control point). In practice the CCF is likely to be a charging gateway (CG). The CCF is also known as a charging collection function.

When a call is made in network A charges may be generated by the P-CSCF 4 or by the S-CSCF 11, depending on the basis for the respective charges. Information on the charges is then passed to the CCF 20 that is responsible for the account of the subscriber who is to be charged. The CCF gathers together the charges and at the end of a billing period passes them to a billing unit which bills the subscriber accordingly, either by issuing an invoice or by debiting the subscriber's pre-paid account.

This arrangement is considerably more complex than arises in 2G (second generation) GSM (global system for mobile communications) charging, because there can be numerous different accounting sessions that need to be combined in the CCF in order to accumulate all the charges for the session.

One problem that can arise during charging is that there is a failure of communications over the links 40, 41 to the CCF 20. This may happen because of a physical failure of the link or because of a protocol breakdown. This could cause charging data that is sent to the CCF to be lost, in which case it might be impossible to charge the subscriber correctly for the session. To help deal with this problem it has been proposed that charging data could be sent to two CCFs. In FIG. 1 this is illustrated by the existence of CCF 21, which is connected by links 42, 43 to the P-CSCF 4 and the S-CSCF 11. Although this makes it less likely that charging data will be lost, it introduces some additional problems. First, if a link to one of the CCFs fails then that CCF may be unaware that it has only received part of the charging data, and even if it is identified that at least one of the CCFs only has partial data then in order to acquire the complete data the data stored in both CCFs must be combined. As a result, additional steps must be taken to correlate the data stored in each of the CCFs. This greatly complicates the charging system.

There is a need for an improved way to tackle the acquisition of charging data.

According to one aspect of the present invention there is provided a communication system for supporting a communication session of a terminal, the communication system comprising: at least one charging unit arranged to monitor the communication session and generate a plurality of charging messages together indicating a total charge for the communication session; a primary charging data collection unit, a secondary charging data collection unit and a backup charging data collection unit, each charging collection unit being capable of receiving and correlating charging messages for the communication session; wherein: the or each charging unit is arranged to transmit the charging messages to the primary charging data collection unit or, if the charging unit determines that a charging message for the communication session has not been correctly received by the primary charging data collection unit, to the secondary charging data collection unit; and the primary and secondary charging data collection units are arranged to, if they have received only some of the charging messages for the communication session, transmit the content of the charging messages that they have received for the session to the backup charging data collection unit.

According to a second aspect of the present invention there is provided a method for supporting a communication session of a terminal by means of a communication system comprising: at least one charging unit for a secondary charging data collection unit and a backup charging data collection unit, each charging collection unit being for receiving and correlating charging messages for the communication session; the method comprising: initiating the communication session; monitoring the communication session by means of the charging unit; generating at the charging unit a plurality of charging messages together indicating a total charge for the communication session; and determining at the charging unit whether any of the charging messages previously generated for a session has not been correctly received by the primary charging data collection unit; and if not transmitting charging messages for the session to the primary charging data collection unit and if not transmitting charging messages for the session to the secondary charging data collection unit.

According to a second aspect of the present invention there is provided a backup charging data collection unit for operation in a communication system capable of supporting a communication session of a terminal, the communication system comprising: at least one charging unit arranged to monitor the communication session and generate a plurality of charging messages together indicating a total charge for the communication session; a primary charging data collection unit and a secondary charging data collection unit, the primary and secondary each charging collection units being capable of receiving and correlating charging messages for the communication session; and the or each charging unit is arranged to transmit the charging messages to the primary charging data collection unit or, if the charging unit determines that a charging message for the communication session has not been correctly received by the primary charging data collection unit, to the secondary charging data collection unit; and the primary and secondary charging data collection units are arranged to, if they have received only some of the charging messages for the communication session, transmit the content of the charging messages that they have received for the session to the backup charging data collection unit; the backup data collection unit being arranged to receive and correlate charging messages for the communication session sent to it by the primary and secondary data collection units.

Preferably the backup data collection unit is arranged to, on receiving from the primary and secondary charging data collection units content of charging messages for the session, eliminate duplicate content of charging messages from the received content of charging messages. Preferably the or each charging unit is arrange to, for each of the charging messages for the session that is sent to the secondary charging data collection unit, set a flag in the message indicating that the content of the message may be duplicated in data received by the primary data collection unit, and the backup data collection unit is arranged to eliminate duplicate content of charging messages from the received content of charging messages at least partially in dependence on the setting of the flag in portions of that received content.

Preferably the terminal is associated with a subscriber entity and the communication system includes several charging data collection units and a subscriber database which stores for each subscriber a record of which of the charging data collection units is the primary charging data unit and which is the secondary charging data unit for charging data relating to charges to be attributed to that subscriber. Preferably the communication system is arranged to, on establishment of the session, access the subscriber database to determine which of the charging data collection units is to be the primary charging data collection unit for the session and which of the charging data collection units is to be the secondary charging data collection unit for the session. It will be appreciated that in such arrangements, and optionally in others too, the primary and secondary charging data collection units perform the functions of those units in respect of a session for which they are acting in those roles. For other sessions the same physical units could have their functional roles reversed. Thus a unit that acts as a primary charging data collection unit for one session could act as a secondary data collection unit for another session, and a unit that acts as a secondary charging data collection unit for one session could act as a primary data collection unit for another session.

Preferably the primary and secondary charging data collection units are arranged to, on receiving a charging message from a charging unit, transmit an acknowledgement for that message to that charging unit.

Preferably the or each charging unit is arranged to determine that a charging message has not been correctly received by the primary charging data collection unit if on expiry of a preset period after it has transmitted a charging message the charging unit has not received an acknowledgement for the charging message.

Preferably the charging messages which together indicating a total charge for the communication session include a start message indicative of the commencement of the session.

Preferably the charging messages which together indicating a total charge for the communication session include a charge message indicative of a charge for at least a portion of the session.

Preferably the charging messages which together indicating a total charge for the communication session include a stop message indicative of termination of the session.

The primary charging data collection unit may be arranged to determine that it has received only some of the charging messages for the communication session if on expiry of a preset period after receiving the start message for the session it has not received a stop message for the session. Alternatively, or in addition, it may be arranged to make the same determination if on expiry of a preset period after receiving a charge message for the session no further message for the session has been received there.

The secondary charging data collection unit may be arranged to determine that it has received only some of the charging messages for the communication session if it has received a charge or stop message but no start message for the session. Alternatively, it could send the content of all charging messages it receives for the session to the backup charging data collection unit.

Preferably the terminal is a mobile station capable of communicating by radio with the communication system.

The primary, secondary and backup charging data collection units could be CCFs. The or each charging unit could be a CSCF. The communication system could be a third generation mobile communications system.

The backup charging data collection unit could be a D-FADC-CCF.

The or each charging unit could be arranged to, if it determines that a charging message for the communication session has not been correctly received by the primary charging data collection unit, transmit no further charging messages for that session to the primary charging data collection unit.

The primary charging data collection unit and the secondary charging data collection unit may be adapted to communicate with the backup charging data collection unit by means of the Diameter protocol. The or each charging unit may be adapted to communicate with the primary charging data collection unit and the secondary charging data collection unit by means of the Diameter protocol.

The system may comprise a plurality of charging data collection units. Each charging data collection unit acting as a primary charging data collection unit in conjunction with a secondary charging data collection unit preferably treats as backup charging data collection unit the same unit as does the corresponding secondary charging data collection unit.

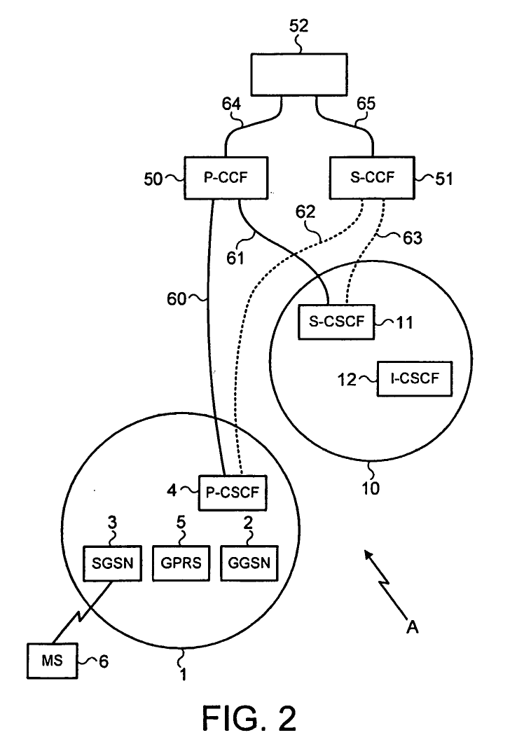

In the drawings, FIGS. 1 and 2 are functional block diagrams of third generation communication systems.

The present invention will now be described by way of example.

FIG. 2 shows a 3G communication system in which components that are analogous to those in FIG. 1 are denoted by the same reference numerals as in FIG. 1. In FIG. 2 there are three CCFS: a primary CCF (P-CCF) 50, a secondary CCF (S-CCF) 51 and a default FADC (faulty accounting data collector) CCF (D-FADC-CCF) 52. The P-CCF 50 is connected by links 60, 61 to the P-CSCF 4 and the S-CSCF 11. The S-CCF 51 is connected by links 62, 63 to the P-CSCF 4 and the S-CSCF 11. The D-FADC-CCF 52 is connected by links 64, 65 to the P-CCF and the S-CCF.

In the system of FIG. 2 there could be numerous CCFs analogous to P-CCF 50 and S-CCF 51, and numerous D-FADC-CCFs analogous to D-FADC-CCF 52. For clarity, only those three are shown in FIG. 2. Each CCF has a D-FADC-CCF assigned to it, for the purpose of correlating faulty accounting data. Each subscriber has a primary CCF and a secondary CCF assigned to it. These are chosen so that both the primary and the secondary CCF assigned to a subscriber have the same D-FADC-CCF assigned to them.

The D-FADC-CCF is arranged to correlate the contents of messages carrying accounting data that it may receive the P-CCF and the S-CCF. In doing so it identifies which messages from either of those sources relate to the same communication session. It can then determine which of those messages have been received from both sources, ignore one of each of those messages, and based on the remaining messages for the communication session determine an overall charge.

An example of the operation of the system of FIG. 2 will now be described.

When the subscriber associated with mobile station 6 registers to a PLMN (in this example the PLMN of network A) in order to conduct a communication session the addresses of the primary and secondary CCFs assigned to that subscriber are downloaded to the relevant P-CSCF 4 and S-CSCF 11. The P-CSCF and the S-CSCF can then start an offline accounting session to the primary CCF for that subscriber, which in this example is taken to be P-CCF 50. Consequently the P-CSCF 4 and the S-CSCF 11 send charging information for the session, as it proceeds, to the P-CCF 50. If the connections 60, 61 to that P-CCF 50 fail during the session the P-CSCF 4 and the S-CSCF 11 set up an offline accounting session to the secondary CCF 51 for the subscriber, which in this example is taken to be S-CCF 51. Failure of a connection 60, 61 may be detected by means of a link-level protocol run over the connections, or by no acknowledgement of a message indicating charging information (e.g. an ACR message—see below) being received by the P-CSCF 4 or the S-CSCF 11, or by failure of the P-CSCF 4 or the S-CSCF 11 even to send such a message. Consequently the P-CSCF 4 and the S-CSCF 11 send charging information for the session, as it proceeds, to the S-CCF 51. That accounting session to the S-CCF 51 is used until the session is released. The session to the P-CCF 50 is terminated when the session to the S-CCF 51 is begun. In this way the P-CCF 50 does not receive an indication that the accounting session has been successfully completed (e.g. by receiving a STOP_RECORD message—see below), so it will be aware that the session has been faulty.

When the session has been released the P-CCF 50 and the S-CCF 51 will both have an incomplete, and therefore faulty set of accounting records for the session. The P-CCF 50 and the S-CCF 51 are configured to, in the event of receiving a faulty set of accounting records for a session, send those records to the D-FADC-CCF that is assigned to them, which in this example is D-FADC-CCF 52. As a result that D-FADC-CCF 52 receives all the available charging records for the session. The D-FADC-CCF 52 correlates the records to establish a combined set of accounting data for the session. That combined set of accounting data can then be used to bill for the call, as appropriate.

It should be noted that since the P-CCF 50 and the S-CCF 51 are configured to pass faulty accounting data for correlation to the backup charging data collection unit, so there is no need to search for faulty records between CCFs.

The manner in which a CCF determines that it has a faulty set of accounting data will now be described. In this example the accounting is performed according to the Diameter protocol. In this protocol accounting is done by means of two messages passed between the CSCFs and the CCFs. The messages for each session have a common unique session ID which identifies messages relating to that session.

1. The ACR (accounting request) message is sent from the client (one of the CSCFs) to a CCF.

2. The ACA (accounting answer) message is an acknowledgement for a previous ACR and is sent from the CCF that received that previous ACR to the client that sent it.

Each ACR or ACA message comprises an attribute value pair (AVP). Each AVP has an attribute which indicates its meaning and a value which indicates the data corresponding to that attribute. The attribute can have forms that include: START_RECORD, INTERIM_RECORD, STOP_RECORD and EVENT_RECORD. During a session a CSCF sends a START_RECORD ACR to indicate that a session has been started; one or more INTERIM_RECORD ACRs to indicate charging values as the session proceeds; and a STOP_RECORD ACR to indicate that the session has been completed. Because Diameter accounting is cumulative the overall charge for a session cannot correctly be determined without all the records for the session. Thus, if a CCF has received a START_RECORD without at least one INTERIM_RECORD and a STOP_RECORD, or a STOP_RECORD without at least one INTERIM_RECORD and a START_RECORD, it cannot determine an overall charge for the session. The CCFs are configured to send such records to their assigned D-FADC-CCF 52 In these situations.

If there is a failure of the link to the P-CCF 50 then accounting messages sent to the S-CCF 51 are marked to indicate that they might duplicate messages received at the P-CCF 50. A D (duplicate) bit could be defined in the charging messages that could be set to allow this to be indicated. The CCFs could be configured to send to the D-FADC-CCF 52 messages for sessions in which one or more messages were received with D-bits set. If such a D-bit is not implemented then the D-FADC-CCF could identify messages from a single session by means of their session IDs, which will be the same, and by means of their time-stamps (e.g. if session IDs are re-used over long periods).

The primary and secondary CCFs are configured not to bill sessions for which they have send charging messages to the D-FADC-CCF. Those sessions will be billed by means of the D-FADC-CCF.

The present invention is not limited to 3G networks.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A communication system for supporting a communication session of a terminal, the communication system comprising:
at least one charging unit arranged to monitor the communication session and generate a plurality of charging messages together indicating a total charge for the communication session;
a primary charging data collection unit, a secondary charging data collection unit and a backup charging data collection unit, each charging collection unit being capable of receiving and correlating charging messages for the communication session;
wherein:
the or each charging unit is arranged to transmit the charging messages to the primary charging data collection unit or, if the charging unit determines that a charging message for the communication session has not been correctly received by the primary charging data collection unit, to the secondary charging data collection unit; and
the primary and secondary charging data collection units are arranged to, if they have received only some of the charging messages for the communication session, transmit the content of the charging messages that they have received for the session to the backup charging data collection unit.

2. A communication system as claimed in claim 1, wherein the backup data collection unit is arranged to, on receiving from the primary and secondary charging data collection units content of charging messages for the session, eliminate duplicate content of charging messages from the received content of charging messages.

3. A communication system as claimed in claim 2, wherein the or each charging unit is arrange to, for each of the charging messages for the session that is sent to the secondary charging unit, set a flag in the message indicating that the content of the message may be duplicated in data received by the backup data collection unit, and the backup data collection unit is arranged to eliminate duplicate content of charging messages from the received content of charging messages at least partially in dependence on the setting of the flag in portions of that received content.

4. A communication system as claimed in claim 1, wherein the terminal is associated with a subscriber entity and the communication system includes several charging data collection units and a subscriber database which stores for each subscriber a record of which of the charging data collection units is the primary charging data unit and which is the secondary charging data unit for charging data relating to charges to be attributed to that subscriber.

5. A communication system as claimed in claim 4, wherein the communication system is arranged to, on establishment of the session, access the subscriber database to determine which of the charging data collection units is to be the primary charging data collection unit for the session and which of the charging data collection units is to be the secondary charging data collection unit for the session.

6. A communication system as claimed in claim 1, wherein the primary and secondary charging data collection units are arranged to, on receiving a charging message from a charging unit, transmit an acknowledgement for that message to that charging unit.

7. A communication system as claimed in claim 1, wherein the or each charging unit is arranged to determine that a charging message has not been correctly received by the primary charging data collection unit if on expiry of a preset period after it has transmitted a charging message the charging unit has not received an acknowledgement for the charging message.

8. A communication system as claimed in claim 1, wherein the charging messages which together indicating a total charge for the communication session include a start message indicative of the commencement of the session.

9. A communication system as claimed in claim 1, wherein the charging messages which together indicating a total charge for the communication session include a charge message indicative of a charge for at least a portion of the session.

10. A communication system as claimed in claim 1, wherein the charging messages which together indicating a total charge for the communication session include a stop message indicative of termination of the session.

11. A communication system as claimed in claim 10, wherein the primary charging unit is arranged to determine that it has received only some of the charging messages for the communication session if on expiry of a preset period after receiving the start message for the session it has not received a stop message for the session.

12. A communication system as claimed in claim 10, wherein the secondary charging unit is arranged to determine that it has received only some of the charging messages for the communication session if it has received a charge or stop message but no start message for the session.

13. A communication system as claimed in claim 1, wherein the terminal is a mobile station capable of communicating by radio with the communication system.

14. A communication system as claimed in claim 1, wherein the primary, secondary and backup charging data collection units are CCFs.

15. A communication system as claimed in claim 1, wherein the or each charging unit is a CSCF.

16. A communication system as claimed in claim 1, wherein the communication system is a third generation mobile communications system.

17. A communication system as claimed in claim 1, wherein the or each charging unit is arranged to, if it determines that a charging message for the communication session has not been correctly received by the primary charging data collection unit, transmit no further charging messages for that session to the primary charging data collection unit.

18. A communication system as claimed in claim 1, wherein the primary charging data collection unit and the secondary charging data collection unit are adapted to communicate with the backup charging data collection unit by means of the Diameter protocol.

19. A communication system as claimed in claim 1, wherein the or each charging unit is adapted to communicate with the primary charging data collection unit and the secondary charging data collection unit by means of the Diameter protocol.

20. A communication system as claimed in claim 1, wherein the system comprises a plurality of charging data collection units, and each charging data collection unit acting as a primary charging data collection unit in conjunction with a secondary charging data collection unit treats as backup charging data collection unit the same unit as does the corresponding secondary charging data collection unit.

21. A method for supporting a communication session of a terminal by means of a communication system comprising: at least one charging unit for a secondary charging data collection unit and a backup charging data collection unit, each charging collection unit being for receiving and correlating charging messages for the communication session; the method comprising:
initiating the communication session;
monitoring the communication session by means of the charging unit;
generating at the charging unit a plurality of charging messages together indicating a total charge for the communication session; and
determining at the charging unit whether any of the charging messages previously generated for a session has not been correctly received by the primary charging data collection unit; and if not transmitting charging messages for the session to the primary charging data collection unit and if not transmitting charging messages for the session to the secondary charging data collection unit.

22. A backup charging data collection unit for operation in a communication system capable of supporting a communication session of a terminal, the communication system comprising: at least one charging unit arranged to monitor the communication session and generate a plurality of charging messages together indicating a total charge for the communication session; a primary charging data collection unit and a secondary charging data collection unit, the primary and secondary each charging collection units being capable of receiving and correlating charging messages for the communication session; and the or each charging unit is arranged to transmit the charging messages to the primary charging data collection unit or, if the charging unit determines that a charging message for the communication session has not been correctly received by the primary charging data collection unit, to the secondary charging data collection unit; and the primary and secondary charging data collection units are arranged to, if they have received only some of the charging messages for the communication session, transmit the content of the charging messages that they have received for the session to the backup charging data collection unit; the backup data collection unit being arranged to receive and correlate charging messages for the communication session sent to it by the primary and secondary data collection units.
